(19) United States
(12) Patent Application Publication
(10) Pub. No.: US 2024/0065320 A1
(43) Pub. Date: Feb. 29, 2024

(54) Cannabidiol Electronic Liquid Pod for Cigarettes and Vaporizer

(71) Applicant: Troy D. Vann, Fairfield, CA (US)

(72) Inventor: Troy D. Vann, Fairfield, CA (US)

(21) Appl. No.: 17/822,355

(22) Filed: Aug. 25, 2022

(51) Int. Cl. A24F 40/42; A24F 7/00; A24F 40/10; A24F 40/44; A24F 40/46; A24F 40/60; A24F 40/90; H01F 7/02; H01M 10/44; H01M 10/48

(52) U.S. Cl. CPC A24F 40/42; A24F 7/00; A24F 40/10; A24F 40/44; A24F 40/46; A24F 40/60; A24F 40/90; H01F 7/02; H01M 10/44; H01M 10/488; H01M 2220/30

(57) ABSTRACT

Disclosed in the present invention is a cannabidiol electronic liquid pod for cigarettes and vaporizer, comprising a ceramic mouth piece at the apex of the pod; an electronic liquid pod fixed to the ceramic mouth piece; external metal case shown as body front connected to the magnetic charge, and an external metal case presented as body back. The e-liquid pod has all-in-one device features, a top fill system, mouthpiece cap, tight buttonless draw, magnetic pod connection, and drop the pod into the magnetic housing. The said pod has a LED indicator on the pod mod that shows the battery life whereby pass-through charging feature of this pod mod is quite convenient. The pod designed to enable the user charge the battery by placing the bottom of the pod mod into the magnetic charge port.

### TECHNICAL FIELD

The present invention generally, relates to electronic cigarettes and in particularly to an electronic pod containing cannabidiol electronic liquid for electronic cigarettes and vaporizer that provide adult smokers with sustainable alternatives to nicotine.

### BACKGROUND ART

CBD stands for cannabidiol, and it is actually an oil derived from the plant called cannabis (marijuana). Many people are mistaking the two things, and some things should be known about the difference between CBD and cannabis. At its core, CBD is a dietary supplement made from organic ingredients, but it can be taken in all sorts of ways.

Cannabis is the plant that causes the effects of getting high, and the reason behind this is called THC. This stands for tetrahydrocannabinol and is the main compound that allows people to experience various psychoactive effects in the brain. On the other hand, cannabidiol does not have this compound, and this way, you will not get high for sure. For this product to be considered legal, companies that produce this medicine must abide by the law. If the THC levels are above zero-point-three percent, then they will not be considered as a legal product. This way, you are guaranteed that the high effects will not be present when you consume this medicine.

Current vaporizers may be used with a variety of materials, such as e-liquid, extracts, oil concentrates, loose-leaf or dry-herb. However, use of each different material requires a separate vaporizer, as the vaporizers are not interchangeable among various materials. Vaporizers are used for aerosolizing or vaporizing an active ingredient within plant matter, such as cannabis, tobacco or other herb blends, and or aerosolizing/vaporizing the concentrates of the active ingredients, such as tobacco or medical cannabis oils like THC or CBD.

Vaporization and aerosolizing of the active ingredients is performed by heating the plant matter or concentrate to the point of where the active ingredients boil, evaporate, or vaporize without combusting the plant matter or concentrates, which some consider to be a better alternative to smoking. By avoiding combustion of the plant matter/oil, a user does not inhale harmful byproducts produced from smoking (e.g., tar, carcinogens, etc.). Furthermore, vaporizing is considered to be a more efficient material delivery method, as opposed to other methods, such as ingestion.

Vaporizers currently come in shapes approximating a cigarette or cigar, but larger. They are clunky with little thought to the shape, including the portability of the shape. There is not vaporizer that can easily fit in one's pocket in a non-obtrusive matter. Sophisticated design changes are necessary to create a slim profile, credit card shaped vaporizer that can fit into a wallet or non-obtrusively slim into a pocket.

Common types of currently used vaporizers include wax, oil-concentrate vaporizers and dry-herb/loose-leaf vaporizers. The vaporizers may utilize one of two heating methods: conduction heating or convection heating. Conduction heating methods may be used in both wax/oil-concentrate vaporizers and dry-herb/loose-leaf vaporizers. For oil concentrates, conduction heating includes a resistive metal coil is typically used to heat up the oils by applying the oils directly to the coil heating element. For dry herb vaporizers, the heating method includes filling a metal bowl or container with an herb, and then using an exterior heating element for heating.

In convection heating, primarily for dry-herb or loose-leaf materials, air is heated before flowing through the herb, using a resistive material coil. When the hot air flows through the dry-herb/loose-leaf, it causes the active ingredients to vaporize without combusting the herb or plant matter. However, such current vaporizers, whether utilizing convection or conduction heating, are not adaptable to different user designs and preferences. Specifically, current vaporizers do not allow for a user to interchange or modify heating methods for different materials. Instead, a user is required to purchase alternative vaporizers for each desired modification.

It would be desirable, therefore, to provide a vaporizer with a modular design, such that one vaporizer may be used with different types of materials. It would be further desirable for the modular vaporizer to provide for user customization, such as the ability to include add-on accessories or modify certain features of the vaporizer. It would be yet further desirable for the modular vaporizer to provide systems and method for interchangeable heating preferences.

Current vaporizers also tend to cause impurities, which are then inhaled when used. These impurities can be caused by the device itself, as well as by the heating elements used in traditional vaporizer devices, particularly metal heating elements. It would be desirable, therefore, to provide an all-glass heating element, reducing and/or eliminating impurities caused by metals, improving flavor and increasing the purity of vapor. It would be further desirable to provide an all-glass heating element that eliminates contact between metals or harmful materials and vaporized materials, such as liquids, oils or herbs.

The patent publication number U.S. Ser. No. 10/278,426B2 discloses a modular vaporizer. It describes a vaporizer with a modular body design is disclosed. The vaporizer may include an atomizer with a bowl and a heating element. The heating element may be formed of glass. The vaporizer may be formed with an open architecture, such that various components may be interchangeably removed or modified. The vaporizer may be modified with different airways, batteries, atomizers or other suitable devices. The vaporizer may be formed with a slim profile to fit unobtrusively into a pocket.

The patent publication number US20130298905A1 describes an electronic vaporizing device and methods for use. It teaches of devices and methods for vaporizing active ingredients of a selected substance for inhalation using a portable vaporization device are provided herein. In certain aspects, the device includes a portable power source, a heating portion, an inhalation sensor, a temperature sensor, a distal light source, and a grinding portion. In response to an inhalation by a user, the power source energizes a heating element of the heating portion so as to heat air flow to a desired vaporization temperature within a few seconds of detecting inhalation, using convection and radiative heating. The device may include a receptacle for receiving a cartridge containing a pre-prepared substance, such as a liquid, gel, powder, or solid brick, and a grinding portion to allow a user to grind intact portions of cellulose-based material into smaller pieces to facilitate vaporization by manually rotating portions of the device relative to each other.

The patent publication number US20130192615A1 reveals an electronic cigarette. It teaches of an electronic smoking article includes a liquid supply including liquid material, a heater operable to heat the liquid material to a temperature sufficient to vaporize the liquid material and form an aerosol, a wick in communication with the liquid material and in communication with the heater such that the wick delivers the liquid material to the heater, at least one air inlet operable to deliver air to a central air passage upstream of the heater, and a mouth end insert having at least two diverging outlets.

In accordance with the invention as set forth below, an electronic pod containing cannabidiol electronic liquid for electronic cigarettes and vaporizer is provided.

It against this background that there is need to develop and avail user-friendly an CBD electronic pod for cigarettes and vaporizer.

### OBJECTS OF THE INVENTION

The main object of the present invention is to provide an electronic pod and particularly to a cannabidiol electronic liquid pod for electronic cigarettes and vaporizer that will provide adult smokers with sustainable alternatives to nicotine.

### SUMMARY OF THE INVENTION

Disclosed in the present invention is a cannabidiol electronic liquid pod for electronic cigarettes and vaporizer that will provide adult smokers with sustainable alternatives to nicotine.

In one preferred embodiment, the present invention comprises a top fill system, mouthpiece cap, magnetic pod connection, drop the pod into the magnetic housing. There is a led indicator on the pod mod that shows the battery life and a pass-through charging feature of this pod mod is quite convenient.

In another preferred embodiment, the pod has buttonless draw-activated operation, tight draw, charge the battery, place the bottom of the pod mod into the magnetic charge port. The pod does not require that you vary the temperature settings nor the vaping wattage. This means that what you need to do is to recharge its battery and start enjoying the users vape. It is all-in-one device in that the user can drop the pod into the magnetic housing. finally, you can take a draw and start vaping. It is easy to change the pod which has a tight cigarette-like draw. It also has a pre-installed 350 mah battery that lasts for almost 5 hours of vaping.

To the accomplishment of the above and related objects, this invention may be embodied in the form illustrated in the accompanying drawings, attention being called to the fact, however, that the drawings are illustrative only and that changes may be made in the specific construction illustrated and described within the scope of the appended claims.

### BRIEF DESCRIPTION OF FIGURES

FIG. 1 illustrates a cannabidiol electronic liquid pod for electronic cigarettes and vaporizer as described in the present invention.

FIG. 2 illustrates the electronic liquid pod for electronic cigarettes and vaporizer that will.

FIG. 3 shows an electronic liquid pod for electronic cigarettes and vaporizer.

FIG. 4 is presentation of a cannabidiol electronic liquid pod for electronic cigarettes.

FIG. 5 demonstrates a cannabidiol electronic liquid pod for electronic cigarettes that will provide adult smokers with sustainable alternatives to nicotine.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another.

The electronic cigarette is an electronic product simulating a cigarette, and has the same appearance, smoke, taste and sensation as the cigarette. The electronic cigarette is a product which is absorbed by a user after nicotine and the like are changed into steam by means of atomization and the like, and generally comprises a smoke tube for containing nicotine solution, an evaporation device and a battery 3. The atomizer is powered by the battery rod, and can convert the liquid nicotine in the smoke cartridge into mist, so that a user has a feeling similar to smoking when smoking, and the cloud and fog can be swallowed. It can even add various flavors such as chocolate, mint and the like into the cigarette tube according to personal preference.

At present, the current electron cigarette is for saving the cost only with a period of time generally after with, and the leak proofness can become very poor, leads to the tobacco tar seepage easily, inhales the taste variation, and need dismantle when adding the tobacco tar, and loaded down with trivial details complicacy, simultaneously after long-term the use, partial electron cigarette electrode can have contact failure's phenomenon, leads to the product to experience to feel relatively poor, and current partial electronic cigarette adopts disposable battery, environmental protection inadequately. Accordingly, those skilled in the art have provided an electronic cigarette that facilitates refueling to solve the problems set forth in the background above.

Cannabidiol electronic pod inspiration is becoming a global product, backed by science, that provide adult smokers with sustainable alternatives. Developing products that stimulate the senses of adult consumers, while enhancing satisfaction, enjoyment and wellbeing. Non-combustible products have become very popular as healthier alternative to nicotine.

The present invention provides electronic-pod containing CBD e-liquid for e-cigarettes and vaporizer. Search results reveals that JUUL/VUSE has majority of patents but not in the area being availed in the present invention, which teaches of electronic pods for CBD or any other electronic smoking.

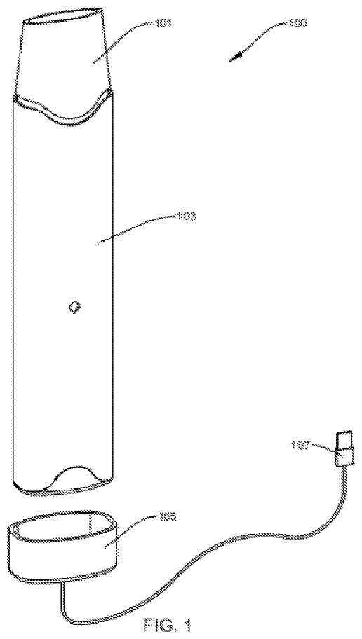

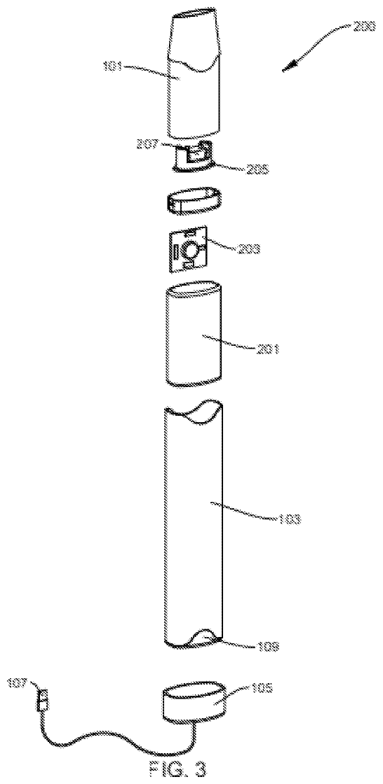

In the present invention according to FIG. 1-FIG. 5 comprising: a top fill system, mouthpiece cap, magnetic pod connection, drop the pod into the magnetic housing 103. There is a led indicator on the pod mod that shows the battery life and a pass-through charging feature of this pod mod is quite convenient. The pod has buttonless draw-activated operation 203 according to FIG. 3, tight draw, charge the battery 201, place the bottom of the pod mod into the magnetic charge port 109. The pod does not require that you vary the temperature settings nor the vaping wattage. This means that what you need to do is to recharge its battery and start enjoying the users vape. It is all-in-one device in that the user can drop the pod into the magnetic housing 103. finally, you can take a draw and start vaping. It is easy to change the pod which has a tight cigarette-like draw. It also has a pre-installed 350 mah battery that lasts for almost 5 hours of vaping 201.

In FIG. 1, the present invention presents a CBD e-pod 100 having a green light vape indicator illuminating charge 101 attached to the external body front that represents the body front which is fixed to a magnetic charge connection 105. The said FIG. 1 further comprises a cable and USB plug charging port 107.

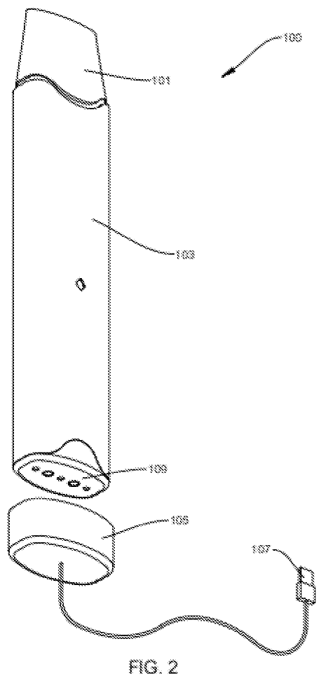

In another embodiment according to FIG. 2, the invention teaches of a cannabidiol electronic liquid pod for cigarettes and vaporizer, comprising a magnetic charging port 109 among other features of FIG. 1.

In FIG. 3, the invention teaches of a pod magnet proprietary magnetic 200 which has heater 205 serving as a holder attached to the ceramic coil 207. It also shows the location of an electronic chip 203 or a draw-activated system acting as a smart battery life indicator in the form of a green and a battery 201 of pre-installed 350 mah battery that lasts for almost five hours of vaping among other features of FIG. 1.

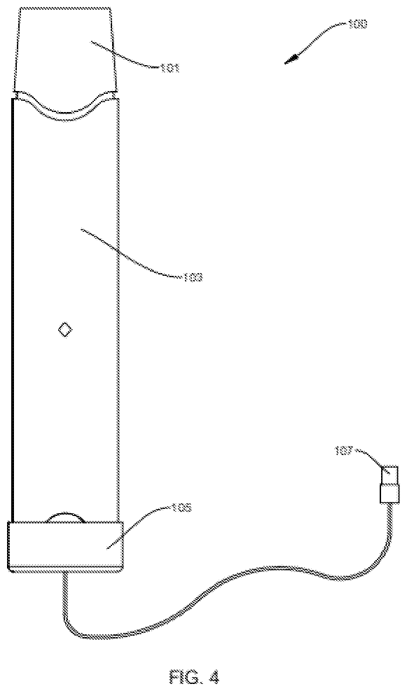

FIG. 4 teaches of the back view of a cannabidiol electronic liquid pod for cigarettes and vaporizer 100, comprising a ceramic mouth piece 101, the body back 103, magnetic charge connection 105 and USB among other features.

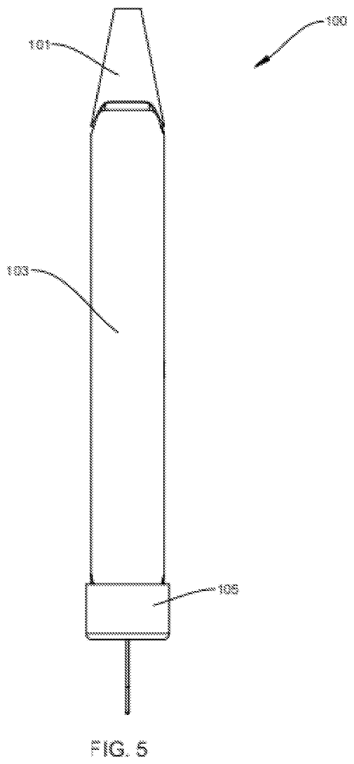

FIG. 5 teaches of the front view of a cannabidiol electronic liquid pod for cigarettes and vaporizer 100, comprising a ceramic mouth piece 101 and the body front 103 among other features. Further the pod enables the vapor to rapidly atomizes from an enhanced surface area liquid reservoir. It has a smart battery life indicator in the form of a green light that blinks when the battery requires charging. It has a simple and smooth mouth to lung vaping. it is perfect for someone who is looking for an exciting and safe alternative to smoking.

The said cannabidiol electronic pod has pod magnets, external metal case, magnetic connection and is easily used by plugging in a USB charging cable 107 as in FIG. 4. The pod has a draw-activated system, an automated draw where the user doesn't have to press any button for vaping. It has an automatic and draw-activated 203. Indeed, it is a breakthrough technology for a smooth, satisfying puff bearing a quick to connect, heat chamber, ceramic coils 207 for all-in-one devices, combined ceramic wick with metal housing, air intake activates the ceramic wick heating element and ceramic coil 207 resistant to heat and work well with very thick liquids.

The present invention further includes a ceramic wick delivers an even purer flavour, ceramic Wicks that have revolutionized CBD Oil vaping industry. It offers great performance with extremely thick liquids, works best for vaping when used at low temperatures, inhaled aerosol temperature, and e-liquid viscosity. The pod has replacement pods are closed systems and contain e-liquid and a heater wick assembly. The pod has a proprietary snap-fit connection, unique and a pod authentication system, docking station and non-combustible.

At its best, the present invention comprises;
1. dimensions: 105 mm×19 mm×10 mm
2. Weight: 22.5 grams
3. Battery capacity: 500 mAh
4. Pod capacity: 1.9 mL
5. No-spill cartridge design
6. Puff activated
7. Take a pod out of its plastic cover.
8. Drop it in the magnetic housing of the battery.
9. Inhale on the mouthpiece.

The present invention is not limited to the embodiments described above. Various changes and modifications can, of course, be made, without departing from the scope and spirit of the present invention. Additional advantages and modifications will readily occur to those skilled in the art. Accordingly, various modifications may be made without departing from the spirit or scope of the general inventive concept as defined by the appended claims and their equivalents.

It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

### INDUSTRIAL APPLICATION

The present invention applies to electronic cigarettes and in particularly to an electronic pod containing cannabidiol electronic liquid for electronic cigarettes and vaporizer that provide adult smokers with sustainable alternatives to nicotine. The present invention further includes a ceramic wick delivers an even purer flavour, ceramic Wicks that have revolutionized CBD Oil vaping industry. It offers great performance with extremely thick liquids, works best for vaping when used at low temperatures, inhaled aerosol temperature, and e-liquid viscosity. The pod has replacement pods are closed systems and contain e-liquid and a heater wick assembly. The pod has a proprietary snap-fit connection, unique and a pod authentication system, docking station and non-combustible.

1. A cannabidiol electronic liquid pod for cigarettes and vaporizer, comprising:
a ceramic mouth piece at the apex of the pod;
an electronic liquid pod fixed to the ceramic mouth piece;
external metal case shown as body front connected to the magnetic charge, and
an external metal case presented as body back.

2. The cannabidiol electronic liquid pod as in claim 1, wherein the pod further comprises;

3. a magnetic charge connection, an USB plug charging cable fixed to the magnetic charge connection and a magnetic charging port.

4. The cannabidiol electronic liquid pod as in claim 1, wherein the pod further comprises a pod magnet proprietary magnetic metal connection, a battery having a pre-installed 350 mah battery that lasts for almost five hours of vaping and an electronic chip in a draw-activated system and smart battery life indicator in the form of a green light that blinks indicate your battery required charging.

5. The cannabidiol electronic liquid pod as in claim 1, wherein the pod an all-in-one device features, a top fill system, a mouthpiece cap, a tight buttonless draw, magnetic pod connection, and a drop the pod into the magnetic housing.

6. The cannabidiol electronic liquid pod as in claim 5, wherein:
the pod has a LED indicator on the pod mod that shows the battery life whereby pass-through charging feature of this pod mod is quite convenient, wherein the buttonless draw is activated when the pod is in operation;
the pod designed to enable the user charge the battery by placing the bottom of the pod mod into the magnetic charge port, and
the pod does not require that the user to vary the temperature settings nor the vaping wattage, enabling the user not to recharge the battery prior to enjoying the vape.

7. The cannabidiol electronic liquid pod as in claim 6, wherein the pod is designed to enable user drop the pod into the magnetic housing, take a draw and start vaping.

8. A cannabidiol electronic liquid pod for cigarettes and vaporizer, comprising:
a means to easily change the pod;
a tight cigarette-like draw;
a pre-installed 350 mah battery that lasts for almost 5 hours of vaping, and
a means that enables vapor rapidly atomizes from an enhanced surface area liquid reservoir;

9. The cannabidiol electronic liquid pod as in claim 8, wherein the pod further comprises a smart battery life indicator in the form of a green light that blinks when your battery requires charging, wherein the pod further comprises a simple and smooth mouth to lung vaping as an exciting and safe alternative to smoking.

10. The cannabidiol electronic liquid pod as in claim 8, wherein the pod further comprises:
pod magnets;
an external metal case;
a magnetic connection; and
a pot for plugging in a USB charging cable.

11. The cannabidiol electronic liquid pod as in claim 8, wherein the draw-activated system in which the automated draw has provisions by which the user does not need to press any button for vaping.

12. The cannabidiol electronic liquid pod as in claim 11, wherein the pod has a heat chamber, automatically activated draws, ceramic coils for all-in-one devices, combined ceramic wick with metal housing, air intake activates the ceramic wick heating element and quick to connect for a smooth, satisfying puff.

13. The cannabidiol electronic liquid pod as in claim 12, wherein the pod has ceramic coil resistant to heat and work well with very thick liquids and ceramic wick delivers an even purer flavour, wherein the ceramic wicks have revolutionized CBD oil vaping.

14. The cannabidiol electronic liquid pod as in claim 13, wherein the pod offers great performance with extremely thick liquids enabling it to work best for vaping when used at low temperatures, wherein the pod has inhaled aerosol temperature, and e-liquid viscosity.

15. The cannabidiol electronic liquid pod as in claim 14, wherein:
the replacement pods are closed systems and contain e-liquid and a heater wick assembly, and
the pod has a proprietary snap-fit connection, unique and a pod authentication system.

16. The cannabidiol electronic liquid pod as in claim 15, wherein the pod further comprises a docking station and non-combustible material.

17. The cannabidiol electronic liquid pod as in claim 16, wherein the pod further comprises:
dimensions of about 105 mm×19 mm×10 mm;
weight of about 22.5 grams;
a battery capacity: 500 mAh;
a pod capacity: 1.9 mL;
a no-spill cartridge design, and
a puff activated device;

18. A method of using a cannabidiol electronic liquid pod for cigarettes and vaporizer, comprising steps of:
i) taking a pod out of its plastic cover;
ii) dropping it in the magnetic housing of the battery, and
iii) inhaling on the mouthpiece.
